(19) United States
(12) Patent Application Publication
(10) Pub. No.: US 2026/0266956 A1
(43) Pub. Date: Sep. 10, 2026

(54) LIDAR-BASED SPORTING OBJECT IDENTIFICATION SYSTEM

(71) Applicant: SportsMEDIA Technology Corporation, Durham, NC (US)

(72) Inventors: Gerard J. Hall, Durham, NC (US); Matthew Bertram, Phoenix, AZ (US); Hans Weber, Chapel Hill, NC (US)

(73) Assignee: SportsMEDIA Technology Corporation, Durham, NC (US)

(21) Appl. No.: 19/557,796

(22) Filed: Mar. 5, 2026

Related U.S. Application Data
(60) Provisional application No. 63/767,855, filed on Mar. 6, 2025.

(51) Int. Cl. G01S 7/48; A63B 24/00; A63B 102/32; G01S 7/481; G01S 7/487; G01S 17/86; G01S 17/88

(52) U.S. Cl. CPC G01S 7/4802; A63B 24/0021; G01S 7/4813; G01S 7/4873; G01S 17/86; G01S 17/88; A63B 2024/0053; A63B 2102/32; A63B 2220/807; A63B 2220/89

(57) ABSTRACT

A system and method for identifying and locating sporting objects on a sporting terrain, for example, golf balls on a fairway or green using at least one LiDAR-based sensor. Visual cameras identify candidate locations for a golf ball based on identification of colored areas of images corresponding to the golf ball color. Subsequently, one or more LiDAR-based sensors confirm which candidate locations corresponding to a golf ball based on local changes in reflectivity of objects in the candidate areas.

### CROSS-REFERENCES TO RELATED APPLICATIONS

This application is related to and claims priority from the following US patents and patent applications: this application claims priority from and the benefit of U.S. Provisional Patent Application No. 63/767,855, filed Mar. 6, 2025, which is incorporated herein by reference in its entirety.

### BACKGROUND OF THE INVENTION

### 1. Field of the Invention

The present invention relates to systems and methods for identifying a golf ball on a fairway or a green, and more specifically to LiDAR-based systems and methods for golf ball identification.

### 2. Description of the Prior Art

It is generally known in the prior art to provide systems for detecting the presence and location of golf balls during play, especially using laser-based range finding survey systems.

Prior art patent documents include the following:

U.S. Pat. No. 11,986,699 for System and method for estimating final resting position of golf balls by inventors Walker et al., filed Aug. 25, 2023, and issued May 21, 2024, discloses a system for predicting a resting position of a golf ball using ball tracking sensor data to identify an impact location of the ball. Modeling of ball movement following impact may be performed that incorporates measured ball impact physics, impact coordinates, and material properties of ground or objects to which the impact coordinates correspond and, together with historical shot data corresponding to the impact coordinates or an encompassing zone, bounce and roll behavior and/or final resting position predictions may be generated.

US Patent Pub. No. 2013/0085018 for Systems and methods for displaying a golf green and a predicted path of a putt on the golf green by inventors Jensen et al., filed Oct. 1, 2012, and published Apr. 4, 2013, discloses a system for displaying information of a golf putt on a user device including generating a digital terrain map of a golf green, determining a location of a cup, determining a location of a golf ball on the golf green in real time, calculating a projected path of a golf ball from the ball to the cup and displaying information of the ball location, cup location, projected path, aiming path and a flat surface equivalent distance on a user interface of the user device.

U.S. Pat. No. 12,115,425 for Standalone and multigame miniature golf structure by inventors Jones et al., filed Mar. 14, 2024 and issued Oct. 15, 2024, discloses apparatus and methods for a standalone and multi-game miniature golf structure. A structure includes a digital display screen positioned to align vertically with a rear end of a putting surface and sensor(s) positioned below the digital display screen. The sensor(s) are configured to detect lateral positions at which balls cross the rear end. The structure includes processor(s), that for each shot of a plurality of miniature golf games, are configured to send command signals to the digital display screen to display putting target(s); identify, via the sensor(s), a lateral position at which a golf ball crosses the rear end of the putting surface; determine whether the lateral position of the golf ball aligns vertically with any of the putting target(s); and generate a score for the shot based on the lateral position of the golf ball relative to the putting target(s).

US Patent Pub. No. 2022/0284625 for System and method for determining 3d positional coordinates of a ball by inventors Tuxen et al., filed Mar. 4, 2022, and published Sep. 8, 2022, discloses a system including a camera capturing images in a first field of view of a sports ball bouncing and rolling, a storage arrangement, and a processing arrangement. The storage arrangement includes a three-dimensional 3D model of a part of a sports play area and the processing arrangement is configured to: detect a pixel location of a ball in an image; determine, based on intrinsic and extrinsic calibration parameters, a camera-ball line comprising a straight line passing through the camera in the direction of the sports ball and to determine, based on the 3D model, an intersection point of the camera-ball line with the 3D model. The processor outputs the intersection point as a 3D position of the ball in the image.

U.S. Pat. No. 9,288,545 for Systems and methods for tracking and tagging objects within a broadcast by inventors Hill et al., filed Jul. 21, 2015, and issued Mar. 15, 2016, discloses an improved system and method for tracking and tagging objects of interest in a broadcast, including expert indications of desirable and undesirable locations on golf course terrain.

U.S. Pat. No. 11,986,698 for System and method for driving range shot travel path characteristics by inventors Tuxen et al., filed Aug. 17, 2022, and issued May 21, 2024, discloses a method for determining golf shot characteristics includes detecting, in imaging data captured by an imager, a signature of a golf shot launched from a first launch area, a field of view of the imager including one of the first launch area and an area adjacent to the first launch area, and determining, from the imaging data, first golf shot characteristics, the first shot characteristics including a first launch location and a first launch time in combination with determining whether the first launch location and the first launch time correspond to a second launch location and a second launch time for second golf shot characteristics determined from sensor data captured by a further sensor arrangement and when no correspondence is found between the first and second launch locations and the first and second launch times, transmitting the first shot characteristics to a display at the first launch location.

U.S. Pat. No. 11,140,813 for Moisture and vegetative health mapping by inventors Morrison et al., filed Jan. 23, 2019, and issued Oct. 12, 2021, discloses a vegetative health mapping system which creates two-or three-dimensional maps and associates moisture content, soil density, ambient light, surface temperature, and/or additional indications of vegetative health with the map. Moisture content is inferred using radar return signals of near-field and/or far-field radar. By tuning various parameters of the one or more radar (e.g. frequency, focus, power), additional data may be associated with the map from subterranean features (such as rocks, soil density, sprinklers, etc.). Additional sensors (camera(s), lidar, IMU, GPS, etc.) may be fused with radar returns to generate maps having associated moisture content, surface temperature, ambient light levels, additional indications of vegetative health (as may be determined by machine learned algorithms), etc. Such vegetative health maps may be provided to a user who, in turn, may indicate additional areas for the vegetative health device to scan or otherwise used to recommend and/or perform treatments.

U.S. Pat. No. 8,396,664 for 3-D golf course navigation device and image acquisition method by inventor Engstrom, filed Aug. 31, 2010, and issued Mar. 12, 2013, discloses three-dimensional, topographic data (x, y, z) for a golf course navigation device. In an embodiment of the invention, three data sets are acquired for each golf hole: (1) geospatial digital image data, (2) geospatial terrain data including elevation and topographic measurements, and (3) object data pertaining to trees, bushes, water hazards, buildings, and any other objects present. Each hole is mapped using high resolution airborne photogrammetry and in some cases, light detection and ranging acquisition sensors. Geospatial, three-dimensional terrain data is acquired using a photogrammetry and/or stereo photogrammetry compilation. Object data is acquired from measurements taken from ground level. From all of this acquired data, a three-dimensional (x, y, z) geospatial model is built and then integrated into 3-D gaming, visualization and web mapping environments such as Microsoft Bing Maps, Google Earth, and various mobile and golf cart mounted, golf course navigation systems.

US Patent Pub. No. 2024/0325847 for Interactive artificial intelligence golf assistant system by inventors Peterson et al., filed Jun. 8, 2024 and published Oct. 3, 2024, discloses a system for interactively providing golf swing guidance to a user on a golf course including a database coupled to a remote server to collect, store and maintain updated topography of golf courses based on LIDAR, a club sensor configured to removably attach to one or more portions of the golf club and further configured to collect the club sensor golf club swing data as the user operates the golf club in a practice swing, a remote server configured to interactively identify a location of a user on the LIDAR topography when positioned at a golf course using a real-time kinematics device, a user audio device wirelessly coupled to the remote server configured to interactively communicate feedback guidance to and from the user of golf club selection and golf club swing adjustments.

U.S. Pat. No. 10,512,831 for Golf aid including heads up display for green reading by inventors Leech et al., filed Oct. 22, 2018, and issued Dec. 24, 2019, discloses an electronic golf aid system for assisting users with reading greens on golf courses including a camera that captures images of the user's field of view, and an electronic display device with a display screen that displays captured images. A processor, which communicates with the camera and display device, is programmed to: receive signals from the camera indicative of images of a golf ball and a cup on the green; determine respective locations for the golf ball and cup; determine a perspective view of the topology of the green between the golf ball and cup from the user's point of view; determine, based on the green's topology, a proposed trajectory line from the golf ball's location to the cup's location; and direct the electronic display device to display the proposed trajectory line superimposed on the surface of the green as the green is shown in real-time on the display screen.

### SUMMARY OF THE INVENTION

The present invention relates to systems and methods for identifying a golf ball on a fairway or a green, and more specifically to LiDAR-based systems and methods for golf ball identification.

It is an object of this invention to provide an accurate golf ball range finding system that is cheaper and easier to implement than existing laser survey systems.

In one embodiment, the present invention is directed to a LiDAR-based system for identifying and locating golf balls during play as described herein.

In another embodiment, the present invention is directed to a LiDAR-based method for identifying and locating golf balls during play as described herein.

These and other aspects of the present invention will become apparent to those skilled in the art after a reading of the following description of the preferred embodiment when considered with the drawings, as they support the claimed invention.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

FIG. 1 illustrates a perspective view of an optical sensor system used to generate image data according to one embodiment of the present invention.

FIG. 2 illustrates a schematic flow diagram of a process for detecting and locating one or more objects, such as golf balls, on a golf course according to one embodiment of the present invention.

FIG. 3 is a graph showing the reflectance of grass at different LiDAR wavelengths.

FIG. 4 is a diagram showing the application of band pass filters at 450 nm and 650 nm that are applied according to one embodiment of the present invention.

FIG. 5 illustrates a graphical depiction of point cloud data for a golf course generated according to one embodiment of the present invention.

FIG. 6 illustrates a graphical depiction of a golf course according to one embodiment of the present invention.

FIG. 7A illustrates a graphical depiction of a golf course generated using LiDAR data according to one embodiment of the present invention.

FIG. 7B illustrates a non-green camera data representation of the same area shown in FIG. 7A.

FIG. 8 illustrates a graphical depiction of a golf course according to one embodiment of the present invention.

FIG. 9 illustrates a camera image with initial identification of candidate objects before candidate refinement according to one embodiment of the present invention.

FIG. 10 is a schematic diagram of a system of the present invention.

### DETAILED DESCRIPTION

The present invention is generally directed to systems and methods for identifying a golf ball on a fairway or a green, and more specifically to LiDAR-based systems and methods for golf ball identification.

In one embodiment, the present invention is directed to a LiDAR-based system for identifying and locating golf balls during play as described herein.

In another embodiment, the present invention is directed to a LiDAR-based method for identifying and locating golf balls during play as described herein.

As golf grows as a sport and competing professional leagues develop to capture audience attention, one area of competition between leagues is on the quality, clarity, and entertainment value of the broadcasts of each league. In order to score golf, all that needs to be displayed is the number of strokes and par value for each hole. However, additional graphics provide entertainment value above merely showing the raw score. For example, the SHOTLINK system of the PGA TOUR, which utilizes a combination of lasers and cameras to find golf ball location. Using the data from the lasers and cameras, a platform then is able to show the shot path from each shot from the first tee until the ball goes into the hole, providing additional data and graphics.

While the use of systems such as SHOTLINK provide the opportunity for additional data and graphics, implementation of these systems is often expensive, obtrusive, and potentially time-consuming. In order to function properly, systems of this type require numerous sensors of different times organized around different parts of the golf course. Either these systems require complicated installations of automated lasers near the ground to track the ball, or require personnel to carry handheld lasers to track the ball. The number of required sensors and the positioning of those sensors are especially problematic in golf for several reasons. First, unlike stadiums or confined fields in other sports, it is often logistically difficult to place power and communication cables for each individual sensor arranged around the golf course, with cable often needing to stretch long distances and/or requiring specialized equipment for the sensors. Second, golf courses, especially renowned ones where broadcasted tournaments are held, place a premium on the beauty of the course. As such, these golf courses often prefer not to have complicated installations and large amounts of cables that disturb this idyllic environment or which potentially damage the field itself.

Therefore, what is needed is a system capable of functioning with fewer sensor devices and with less strict requirements as to the placement and distribution of the sensor devices relative to prior art embodiments. However, in limiting the number of required sensors and logistics regarding those sensors, maintaining a high degree of accuracy in determining the position of the golf ball is important to ensure the quality of the resulting data. Additionally, what is needed is a system capable of obtaining depth information and measure the contours of identified objects, which is beyond the capabilities of existing camera-based systems.

Referring now to the drawings in general, the illustrations are for the purpose of describing one or more preferred embodiments of the invention and are not intended to limit the invention thereto.

The platform of the present invention is able to incorporate LiDAR sensor data in combination with visual camera data to identify and locate golf balls in play (i.e., on a golf green, fairway, or other portions of a golf course). Location data for the golf balls is used to generate graphics for a broadcast of a golf event, showing the new location for the golf ball with each stroke between the tee and the hole. In one embodiment, location data for the golf balls generated according to the present invention is used to inform betting lines by determining difficult of a subsequent shot (e.g., paired with terrain data for a particular portion of the golf course).

In one embodiment, the platform is operable to identify a (“sporting object”), a term described herein as including a golf ball, basketball, tennis ball, bowling ball, hockey puck, ping-pong ball, football, water-polo ball, volleyball, badminton birdie, tee ball, soccer ball, baseball, curling stones/rocks, cricket ball, croquet ball, rugby ball, shot put, handball, hammer (for hammer-throw), discus, javelin, frisbee, lacrosse ball, pickleball, paddleball, wiffle ball, foosball, softball, or any object used in a sporting event. In another embodiment, the platform is operable to identify a (“sporting instrument”), a term described herein as including a golf club, racket, paddle, hockey stick, net, chain, lacrosse stick, bat, or any other sporting instrument.

In one embodiment, the platform is operable to identify the sporting object and/or the sporting instrument to create location data based on terrain data, wherein terrain data includes portions or the entirety of a course (e.g., golf or flying disc), court (e.g., basketball or tennis), field (e.g., football or baseball), pool or any type of aquatic arena, rink (e.g., ice skating rink), table (e.g., ping-pong or foosball), or any other sporting terrain.

In one embodiment, the platform is operable to generate graphics for a broadcast of a golf event, basketball event, hockey event, tennis event, or any other sporting event based on location data of the sporting object and/or sporting instrument. The graphics for the broadcast of the sporting event are operable to illustrate a new location of the sporting object and/or sporting instrument based on the location data.

In one embodiment, the present invention includes at least one LiDAR sensor oriented toward a portion of a golf course. In one embodiment, the at least one LiDAR sensor is positioned at a high elevation, such as in a tree or on a cliff side. In one embodiment, the at least one LiDAR sensor is housed together with or otherwise collocated with at least one visual camera sensor. Collocation of the at least one LiDAR sensor and the at least one visual camera sensor allows for fewer power and transmission cables to be used in the system. In one embodiment, the at least one LiDAR sensor and/or the at least one visual camera sensor are connected to at least one local power storage unit (e.g., one or more batteries) configured to provide power to the sensors without needing a separate power cable. In one embodiment, the at least one LiDAR sensor and/or the at least one visual camera sensor are connected to at least one wireless transmission unit, configured to communicate via a wireless local area network (WLAN) (e.g., WI-FI), a wireless personal area network (WPAN) (e.g., BLUETOOTH), and/or a cellular network to at least one processing unit. In another embodiment, the at least one LiDAR sensor and/or the at least one visual camera sensor are collocated with at least one local processing unit, to allow for an edge processing architecture.

In one embodiment, a local processing unit and/or a remote server receives sensor data from the at least one visual camera sensor corresponding to a snapshot of an area of a golf course (e.g., a particular green, a fairway, an entire hole, etc.) or any other sporting terrain. A computer vision analysis module, preferably including use of one or more machine learning-based computer vision analysis techniques, is configured to automatically analyze the at least one visual camera sensor data and flag areas corresponding to potential golf ball locations or any other sporting object locations. In one embodiment, potential golf ball locations are determined by color analysis of the snapshot, detecting relatively isolated points having the same or similar color to a known color of the golf ball (e.g., white). In another embodiment, the potential sporting object locations are determined by color analysis of the snapshot, detecting relatively isolated points having the same or similar color to a known color of the sporting object. In one embodiment, the computer vision analysis module receives selection of a golf ball color or any other sporting object color from at least one operator user device (e.g., a cell phone, a computer, a tablet, etc.) and/or from at least one server. Based on the golf ball color or any other sporting object color received, the computer vision analysis module analyzes the snapshot for the selected color. In one embodiment, if no golf ball color is received, then the computer vision analysis module automatically defaults to a most recently received golf ball color or to the color white, given the high likelihood that the balls used are white. In another embodiment, if no sporting object color is received, then the computer vision analysis module automatically defaults to a most recently received sporting object color or to the color typically associated with the sporting object (e.g., orange for a basketball, yellow for a tennis ball, white for a baseball, and any other typical sporting object and color combination).

In one embodiment, the at least one visual camera sensor periodically generates snapshot images at a set rate. For example, in one embodiment, snapshots are generated every 10 seconds, every 3 minutes, or at any other preset rate. In one embodiment, in each instance of the snapshot being generated, the computer vision analysis module automatically analyzes the snapshots to detect one or more likely candidate areas for the golf ball or any other sporting object. In another embodiment, the at least one visual camera sensor only generates snapshots upon receiving a request from an operating user device and/or a server, or the visual camera increases the frequency at which snapshots are captured based on receiving a request from an operating user device and/or a server. The two paradigms of continuous snapshot generation and generation upon request each provide unique advantages, depending on the priorities of the system operator. The continuous generation paradigm does not require active user inputs in order to begin collecting data and is therefore less likely to miss an important snapshot as a result of operator error. However, generation upon request requires much less processing of potentially unimportant snapshots, thereby reducing required processing power, memory, and power consumption. In a third paradigm, according to another embodiment, snapshot generation occurs upon a trigger event, as detected by one or more sensors. For example, if a motion sensor detects movement of a ball or swing, one or more snapshot images are set to be generated after a preset amount of time (providing time for the ball or at least one other sporting object to land and settle).

After determining one or more candidate locations from the computer vision analysis, the at least one LiDAR sensor performs a scan of the area covered by the snapshot. Localized analysis of the data points generated by the at least one LiDAR sensor around the candidate areas is performed in order to confirm to deny that one or more of the candidate areas correspond to a golf ball or at least one other sporting object. In one embodiment, the localized analysis confirms or denies that a candidate area includes a golf ball via determination of a change in reflectivity of the data points within the candidate area above a preset minimum threshold, or within a preset range. This is useful, as the particular reflectivity of golf balls is unique, even relative to other white objects (or objects of the same color as the golf ball) that are likely to be identified by the visual camera analysis. For example, while a portion of golf shoes is likely to be white and could potentially generate a false positive for a system solely relying upon visual camera data, the reflectivity of white golf shoes is likely to be significantly lower than that of the golf ball, so a lower delta is observed for the shoes relative to the golf ball. By setting a threshold likely to capture change in reflectivity of the golf ball relative to its environment, but unlikely to capture change in reflectivity of a golf shoe or other potential false positives, the system is able to identify the golf ball with a higher degree of accuracy. In another embodiment, the localized analysis confirms or denies that the candidate area includes at least one sporting object via determination of a change in reflectivity of the data points within the candidate area above the preset minimum threshold, or within the preset range. The reflectivity of the at least one sporting object is unique relative to other same-colored objects that are likely to be identified by the visual camera analysis.

The data generated by the at least one LiDAR sensor includes not only reflectivity for each data point, but also distance from the at least one LiDAR sensor for each data point. Because the at least one LiDAR sensor is at a fixed location, a processor is able to quickly translate information for each data point to a three-dimensional location, which is used to inform graphics showing the path of the ball with each stroke and to generate highly accurate data for the location of the golf ball, which is able to inform analyses or betting lines. In another embodiment, the three-dimensional location is used to inform graphics showing the path of at least one sporting object with each movement and to generate highly accurate data for the location of the at least one sporting object, which is able to inform analyses or betting lines.

In one embodiment, if no candidate area is detected to be likely to contain a golf ball or at least one other sporting object, then the at least one LiDAR sensor is able to perform a more expansive scan of the area to detect the presence of a golf ball or at least one other sporting object and reflectivity analysis is able to be performed for each point. This step requires substantially more processing than simply checking the candidate areas, so preferably analysis of the entire area scanned by the at least one LiDAR sensor is performed only where the candidate areas do not appear to contain a ball or at least one other sporting object. In one embodiment, if no golf ball or at least one other sporting object is detected, the processor or a server transmits a message warning an operating user device that no ball or at least one other sporting object was found. In another embodiment, if no golf ball or at least one other sporting object is detected, then the threshold of change in reflectivity is changed and the candidate areas are reevaluated to determine a most likely position of the golf ball of the at least one other sporting object.

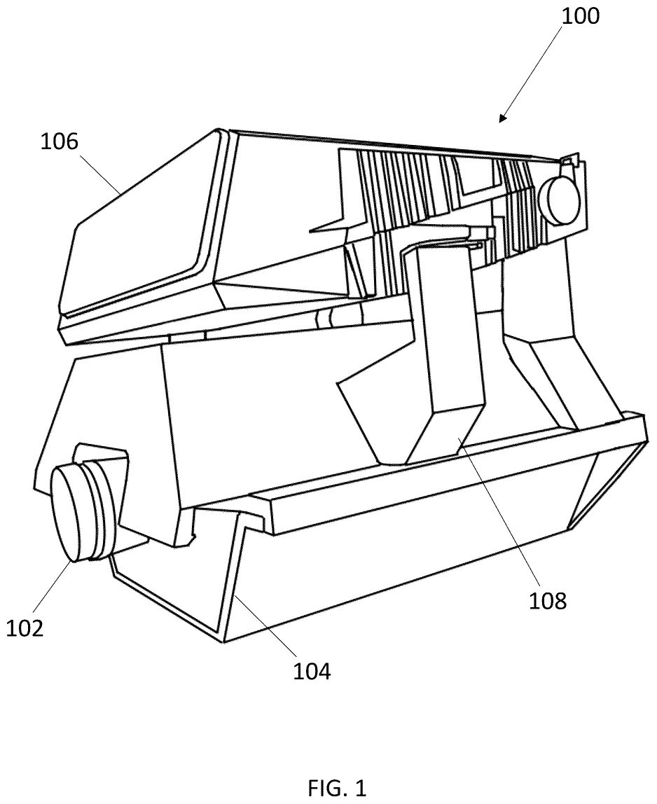

FIG. 1 illustrates a perspective view of an optical sensor system used to generate image data according to one embodiment of the present invention. One or more optical sensor systems 100 are placed around one or more holes of a golf course, on other playing fields, or any other sporting terrain. Preferably, the one or more optical sensor systems 100 are positioned such that a substantial portion of the play area for the hole, of the playing field, or any other sporting terrain is visible from the vantage point of the one or more optical sensor systems 100. The one or more optical sensor systems 100 are used to capture image data and other optical data for the visible area, with a processor able to automatically analyze the optical sensor data to detect and/or determine the location of one or more objects on the hole, playing field, or any other sporting terrain. One of ordinary skill in the art will understand that the present invention is able to utilize any quantity of the optical sensor systems 100, but that, for cost and spatial efficiency, accomplishing identification and location using fewer optical sensor systems is preferable according to one embodiment of the present invention. For example, in a preferred embodiment, each process of identification and/or location implemented according to the present invention only utilizes sensor data from a single optical sensor system 100. Even in this limited embodiment, one of ordinary skill in the art will understand that multiple optical sensor systems 100 are positioned and used at different locations (e.g., one optical sensor system per hole of a course, one optical sensor system per corner of a basketball court, etc.). In another embodiment, two or more optical sensor systems 100 cover and produce data for a common area, with data from each sensor system 100 able to be fused to generate a single representation of the area, or region of interest (ROI).

In one embodiment, the optical sensor system 100 includes at least one LiDAR sensor 106 connected to at least one camera 102. In one embodiment, the at least one LiDAR sensor 106 is configured to operate in a scanning pulsed mode, scanning in a pattern over a visible area, to generate point cloud data. In one embodiment, the point cloud data includes intensity, return number, number of returns, one or more point classification values, red, green, blue (RGB) values, scan angle, scan direction, reflectance, and/or other quantities. In one embodiment, the at least one LiDAR sensor conducts an initial scan of a visible area to construct a 2D and/or 3D point cloud model of the area. This initial scan provides a baseline image of the area to which subsequent scans are compared in order to identify different features. For example, the difference in reflectance of particular points or a cluster of points in a subsequent image relative to the baseline provides an indication of the presence and/or position of one or more objects (e.g., golf balls or any other sporting object) on the green, fairway, or any other sporting terrain. Alternatively, in another embodiment, a baseline image is not required to be generated, and identification is able to be performed based simply on comparison of reflectance of points within a single scan or set of scans.

Furthermore, the reflectance, color, or intensity value of individual points relative to surrounding point values provides information regarding boundaries of objects, as well as assists in identification of particular objects. In particular, this differential in values between adjacent points is important for identifying the location of golf balls, as golf balls typically are white, or at least are a distinct color from the surrounding green or fairway. In one embodiment, the at least one LiDAR sensor scans the environment at a frequency of approximately 20 Hz, but one of ordinary skill in the art will understand that the scanning frequency is able to be varied.

In one embodiment, the at least one LiDAR sensor 106 includes at least one ultra long-range LiDAR sensor 106 (e.g., FALCON K, etc.), allowing the sensor to be placed at a long distance from the ROI, or parts of the ROI, without significantly sacrificing precision. In one embodiment, the at least one LiDAR sensor 106 has a frames per second (FPS) of at least 20. In another embodiment, the at least one LiDAR sensor 106 has a frames per second (FPS) of at least 10. In one embodiment, the at least one LiDAR sensor 106 has an accuracy equal to or better than 4 cm at a distance of 50 m and/or an accuracy of about 5 cm at 200 m, but one of ordinary skill in the art will understand that LiDAR sensors having different degrees of accuracy are also compatible with the present invention.

In one embodiment, the at least one LiDAR sensor 106 is capable of returning two pulses and reporting an elongation value between the first and second pulses. Elongation values hold particular benefits as a golf ball at 35 meters away from the at least one LiDAR sensor 106 has a measured elongation value between about 100 and about 160 nanoseconds, while the surrounding grass has an elongation value of less than 100 nanoseconds, allowing the ball to be distinguished from the surrounding environment. In another embodiment, the elongation value is operable to be measured for a sporting object and a sporting terrain to allow the sporting object to be distinguished from the surrounding sporting terrain. Furthermore, the at least one LiDAR sensor 106 is able to provide return type data as well between first and second pulses.

In one embodiment, the at least one LiDAR sensor 106 is connected to at least one camera 102. In one embodiment, the at least one camera 102 is contained and held in place by an external housing 104, wherein the external housing 104 is connected to the at least one LiDAR sensor 106 by at least one mounting bracket 108. In one embodiment, the external housing 104 further contains one or more processors configured to process data generated by the at least one camera 102 and/or the at least one LiDAR sensor 106, allowing the system to function with some processing at the point of data gathering (i.e., an edge computing paradigm). In another embodiment, one or more processors are connected via wired or wireless connection to the optical sensor system 100, but are remote from the optical sensor system 100 in a traditional or cloud computing paradigm.

In one embodiment, the at least one camera 102 includes a high definition (HD) camera (e.g., ALVIUM 1800C-1620 M, etc.). In one embodiment, the at least one camera 102 is able to support at least 16 MP at 30 FPS. In one embodiment, the at least one camera 102 is able to support at least 2 MP at 85 FPS. In one embodiment, the at least one camera 102 includes at least four camera serial interfaces (CSI). In one embodiment, the one or more processors included in the external housing 104 include one or more graphics processing units (GPUs). In one embodiment, the one or more processors include at least one solid state drive (SSD). In one embodiment, the one or more processors include at least one JETSON ORIN NANO. In one embodiment, the one or more processors are able to support at least 40 trillion operations per second (TOPS). In one embodiment, the one or more processors include at least two camera serial interfaces (CSI). In one embodiment, the one or more processors support 4 or more lanes, with 10 Gbit/s or more. In one embodiment, the one or more processors are able to support Precision Time Protocol (PTP) capabilities.

The use of the at least one camera 102 in conjunction with the at least one LiDAR sensor 106 enhances both the speed and precision with which game objects are identified. The system is able to operate in both “camera-first” and “LiDAR-first” methods. In the camera-first methodology, the at least one camera 102 generates a visual map of the ROI and a machine vision module of the local or remote processors automatically analyzes the visual map to determine one or more likely candidate areas for one or more objects being tracked within the environment. The system of the present invention is able to use any known machine vision technique known in the art, including but not limited to those described in U.S. Pat. Nos. 11,868,863 and 11,961,279, each of which is incorporated herein by reference in its entirety. By identifying potential candidates, the amount of time needed and compute power needed for the LiDAR sensors is thereby highly reduced, as only the target areas need to be examined. In this methodology, the LiDAR serves most importantly as a confirmatory measure for the camera analysis, filtering out false positives (e.g., players' white shoes) and thereby increasing accuracy of the camera. The LiDAR sensors are able to serve as confirmatory measures, as the ability for the point cloud data to determine the shape of the objects being detected allows for filtering of potential object candidates that are, for example, simply glare spots on white shoes of a participant.

In the preferred LiDAR-first methodology, LiDAR analysis is used to first determine one or more candidate objects (e.g., based on local differences in reflectivity). Machine vision-based analysis of camera data is then used to confirm or reject the candidate objects as corresponding to objects of interest. In this methodology, the LiDAR is used primarily for the initial search, with the camera able to detect, for example, that the candidate objects detected by the LiDAR analysis are the correct, expected color. This methodology allows for the object recognition of the camera analysis to be tuned to be more sensitive, as there is reduced risk of false positives in the limited areas being searched. Furthermore, because the LiDAR is able to identify objects not visible to the camera, the LiDAR in this instance reduces the risk of false negatives.

Additionally or alternatively to the camera-first or LiDAR first methodologies, the system of the present invention is able to operate on a coincident breadth basis, wherein both the camera and the LiDAR system scan the entire areas, identifying candidate objects and then the system is able to cross-correlate those candidate objects for overlap in order to determine the likely location of objects of interest. While this methodology requires more compute power and time than the camera-first and LiDAR-first methodologies, it targets both false positives and false negatives by not relying on, initially, the observations of any particular methodology.

Furthermore, the use of LiDAR provides additional capabilities beyond identification of objects, as it provides for the ability to locate the objects in 3D space. Return time data from the point cloud allows LiDAR to determine distances of objects or parts of objects past the sensor. This is of particular benefit, as it allows for 3D locating the object using only a single sensor setup, as opposed to the use of cameras, which requires triangulation from at least two cameras located at different positions. Thus, the LiDAR provides benefits beyond mere identification of which point in a camera image corresponds to an object, but also provides information about where that object is in 3D space.

One of ordinary skill in the art will understand that the present invention is not limited to operating in any particular single one of the identified methodologies. In one embodiment, the system is able to operate in any of the LiDAR-first, camera-first, or coincident breadth methodologies upon receiving a request from a user or a connected user device. Additionally or alternatively, the system is able to alternate between methodologies based on sensor detection of one or more different factors. For example, if the camera detects overall low light levels (e.g., high shading, etc.) that are likely to negatively impact the ability of the camera to effectively distinguish objects, the system is able to switch from a camera-first to a LiDAR-first methodology automatically or even switch to a methodology that entirely relies upon LiDAR detection, without any use of camera data.

In one embodiment, mapping of the environment includes data fusion of LiDAR and camera sensor data. In one embodiment, the data fusion includes You Only Look Once (YOLO) segmentation. Furthermore, in one embodiment, including a plurality of LiDAR sensors, data fusion is also able to include fusion of data from the plurality of LiDAR sensors to create a single mapping. In one embodiment, the system includes a plurality of LiDAR sensors, wherein scans initiated by each of the plurality of LiDAR sensors are initiated at different spatial points, but at the same time, with the scans performed by each of the plurality of LiDAR sensors being fused and stitched together into a single mapping by a processor. This is particularly useful in instances where gathering each of the points in the point cloud of the mapping at substantially the same time is important, as utilizing a single sensor will result in a longer delay between the times when the first data point and the last data point are generated. However, one of ordinary skill in the art will understand that utilizing a plurality of sensors to scan an ROI of a golf course or at least one other sporting terrain is often not necessary, as the state of the course or the at least one sporting terrain most often remains substantially static for sufficient periods of time for a single sensor to complete a full scan without issue.

In one embodiment, the optical sensor system 100 is supported by a stand (e.g., a tripod, etc.) in order to provide the system with sufficient height to effectively survey the ROI. In another embodiment, the optical sensor system 100 is attached, at an elevated position, to one or more other objects, such as a tree, a telephone pole, a wall, or any other suitable object. The optical sensor system 100 is able to be attached to other objects through any suitable connection means, including but not limited to bolts, nails, straps, adhesive, latches, hook-and-loop elements, mounting brackets, and/or other means. In addition to providing height and a vantage to the sensors, attachment to an existing object is advantageous in that it blends the optical sensor system 100 into the environment in which it is placed, reducing the aesthetic impact of the system. One of ordinary skill in the art will understand that the present invention is not limited to use of optical sensor systems 100 connected only in particular ways and is instead inclusive of optical sensors systems 100 set up in various ways (e.g., different set-ups at different holes, corners of courts, divisions of fields, etc.). Flexibility of deployment allows the system to operate at holes without, for example, any trees.

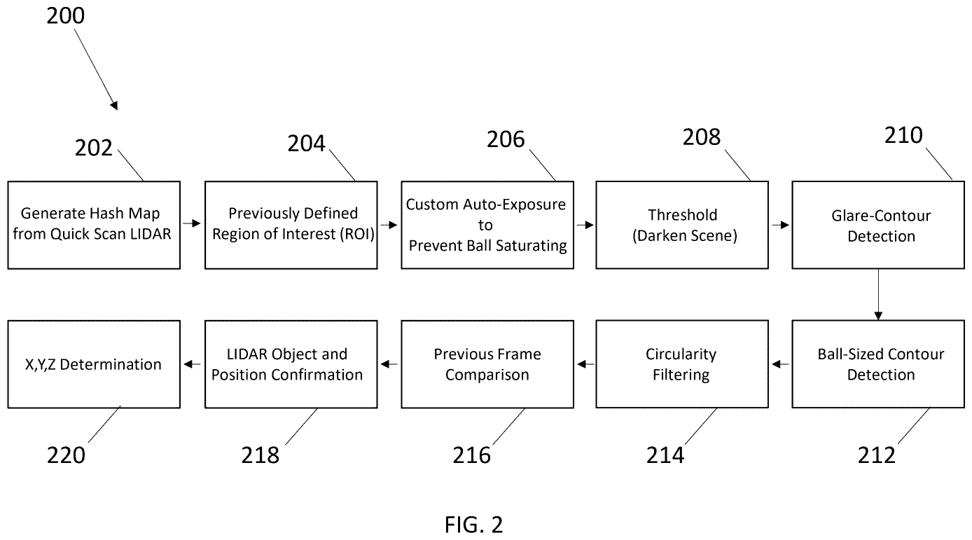

FIG. 2 illustrates a schematic flow diagram of a process for detecting and locating one or more objects, such as golf balls, on a golf course according to one embodiment of the present invention. A process 200 for identifying and locating sporting objects (e.g., golf balls) on a play area (e.g., a golf course or any other sporting terrain) includes first generating a hash map 202 of the environment in an area. In one embodiment, the generating the hash map 202 is conducted by an initial LiDAR scan. In one embodiment, the initial LiDAR scan is performed by the same optical sensor system used to identify and locate the object in later steps of the process 200, or by a different optical sensor system. In another embodiment, the initial LiDAR scan is performed by one or more drones (i.e., autonomous land, aquatic, or aerial vehicles). In one embodiment, additionally or alternatively to the initial LiDAR scan, the one or more drones are configured to generate visual sensor data for the area able to be used in lieu of or in conjunction with the initial LiDAR data to generate a texture mapping of the region.

In one embodiment, one or more ROIs are determined within a visible area 204 based on machine vision analysis of camera data. In order to more accurately determine ROIs based on the camera data, in one embodiment, the process 200 includes automatic exposure adjustment 206 of the camera data in order to prevent saturation of the ball or sporting object. Furthermore, in one embodiment, the process 200 further includes thresholding 208 of the camera data in order to produce more significant contrast in the image to identify the object. This process is able to produce, for example, a non-green, or black-and-white version of the camera data, where the whiteness of a typical golf ball more readily stands out. LiDAR scan data of the ROIs is able to determine contours of objects corresponding to glares identified in the camera data 210. Specifically, the LiDAR scan data is able to determine if ball-sized contours are detected in the ROIs identified in the camera data 212. In one embodiment, circularity filtering 214 is utilized for the ROIs. Circularity filtering helps to ensure that identified ROIs are objects with substantially circular cross sections (i.e., balls, pucks, frisbees, discuses, or any other sporting objects) rather than other objects. In one embodiment, the circularity filter utilizes the equation

$$Circularity = \frac{4 π A}{{P}^{2}} ,$$

wherein A is the sample area and P is the sample perimeter. In one embodiment, the system then implements a threshold cutoff value for the circularity, under which objects are rejected as corresponding to a ball or at least one other sporting object with a substantially circular cross sections. In one embodiment, the system is operable to use temporal frame analysis via previous frame comparison 216 to determine if the identified ball-sized contours were present in a previous, or other past, instance of the point cloud data. Furthermore, by comparison to multiple previous frames (e.g., at t-1, t-2, etc.), the system is able to determine that the pattern of movement of objects matches an expected pattern of movement of a ball or at least one other sporting object with a substantially circular cross sections. Movement pattern analysis is useful for ensuring that movement is not due to factors such as wind or mere movements of the camera itself. This allows the system to filter out objects in the environment that are coincidentally golf-ball shaped and/or which are not directly related to the plan at hand (e.g., an old golf ball resting on the course or at least one other sporting object resting on any other sporting terrain). One of ordinary skill in the art will understand that temporal frame analysis utilizing previous frame comparison is able to be performed both for camera data and for LiDAR data, albeit with the LiDAR data using previous scans or previous data points rather than previous “frames.”

Based on this processing, the system is able to confirm (or reject) the presence of one or more objects of interest in one or more of the ROIs 218. Finally, the LiDAR data is used to determine coordinates (e.g., X, Y, Z coordinates) in 3D space 220 for the one or more identified objects.

However, in another embodiment, the process shown with respect to FIG. 2 is able to be simplified to not require camera data to narrow ROIs. For example, in one embodiment, LiDAR data is utilized to both determine ROIs and confirm the presence or absence of ball-shaped contoured objects and/or at least one other sporting object with a substantially circular cross section within the ROIs. In this embodiment, reflectivity data generated for each point in the point cloud is used to detect the objects, in addition to LiDAR data being used to confirm and locate the objects.

In one embodiment, the process includes an initial calibration step to calibrate the data generated by the LiDAR sensor with the camera data. This is important in correlating raw LiDAR sensor data with actual determined coordinates. In one embodiment, calibration proceeds utilizing one or more calibration elements placed within the area visible to the LiDAR sensor and the camera. In one embodiment, the one or more calibration elements include objects of known size and position, having high reflectivity to both the visible light spectrum detected by the camera and the near IR spectrum detected by the LiDAR sensor. In one embodiment, the one or more calibration elements include barium sulfate (BaSO4) orbs (or barium sulfate objects of other shapes).

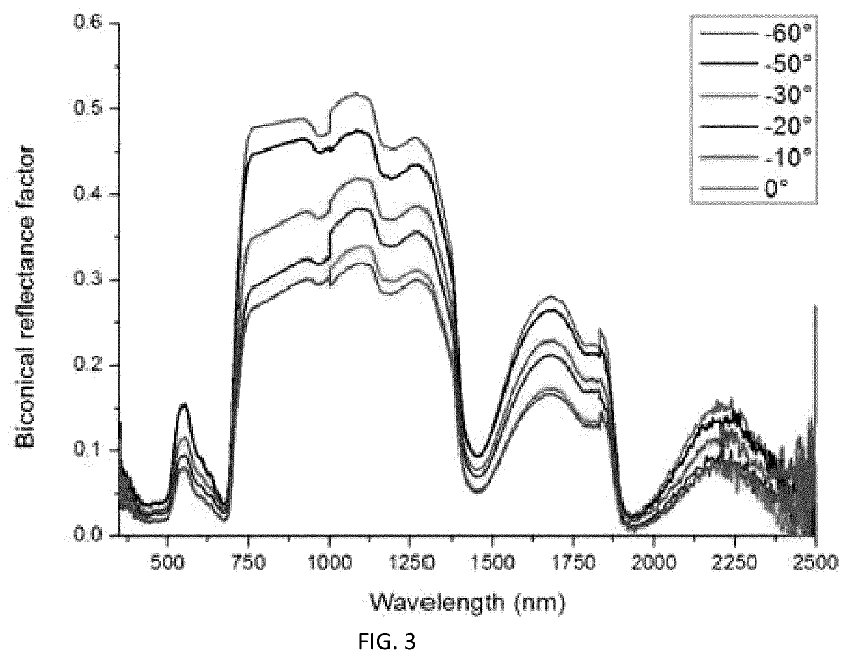

FIG. 3 is a graph showing the reflectance of grass at different LiDAR wavelengths. In one embodiment, the at least one LiDAR sensor of the present invention utilizes 1550 nm wavelength LiDAR. FIG. 3 shows the advantages of using 1550 nm relative to using 905 nm LiDAR, as grass has much greater reflectance around 905 nm compared to around 1550 nm. This means that, when using the 1550 nm wavelength LiDAR, there is greater contrast between the grass and the ball, with a reflectivity difference of at least 50%.

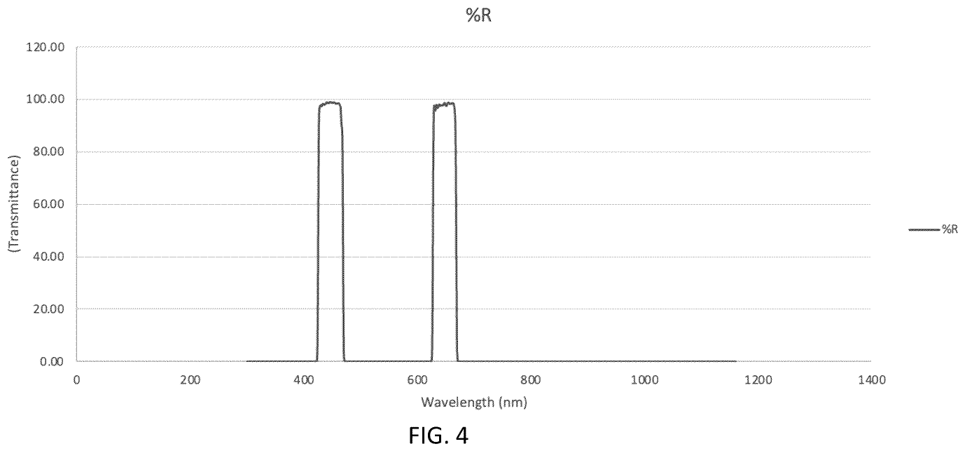

FIG. 4 is a diagram showing the application of band pass filters at 450 nm and 650 nm that are applied according to one embodiment of the present invention. In one embodiment, the process of the present invention includes application of a dual-bandpass filter at 450 nm and 650 nm for the camera data. The 450 nm and 650 nm wavelengths are selected because they match the maximum absorption of grass in the active area of a complementary metal-oxide semiconductor (CMOS) monochromatic camera. Applying this bandpass filter provides a 50-150% increase in measured brightness of a white golf ball relative to a green, grass background when using a CMOS camera. In another embodiment, the process of the present invention includes the application of the dual-bandpass filter at least one nm wavelengths for the camera data, wherein the at least one nm wavelength is selected to match the maximum absorption of the sporting terrain in the active area of the CMOS. In one example embodiment, applying the bandpass filter provides a 50-150% increase in measured brightness of the ice rink relative to the black hockey puck when using a CMOS camera.

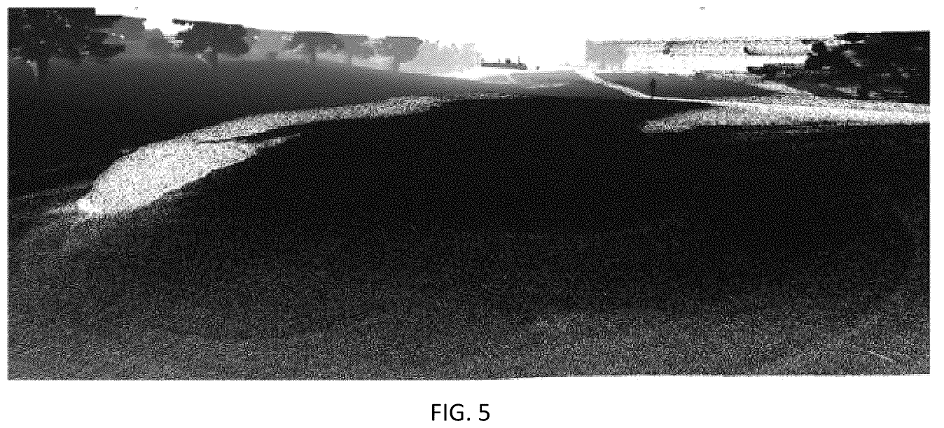

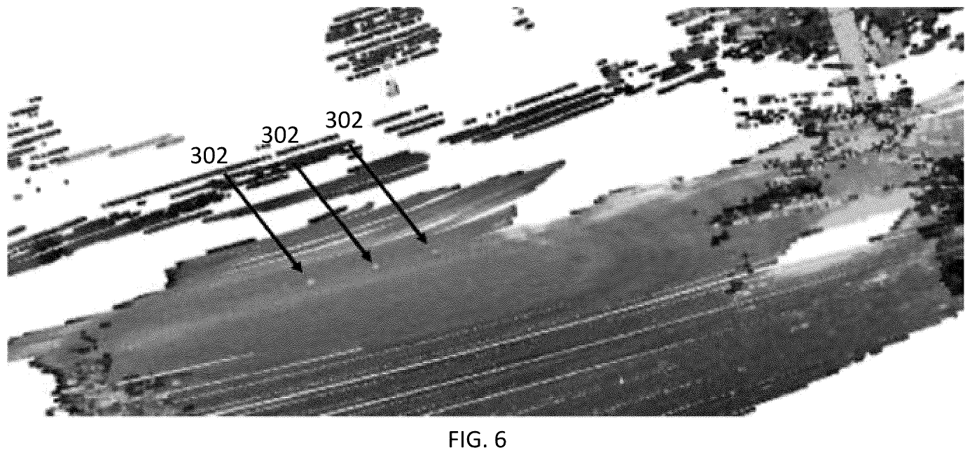

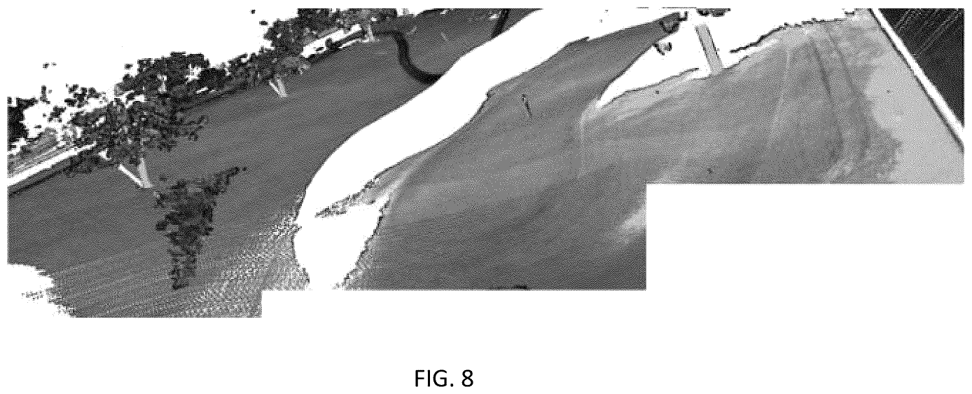

FIG. 5 illustrates a graphical depiction of point cloud data for a golf course generated according to one embodiment of the present invention. FIGS. 6 and 8 illustrate graphical depictions of a golf course according to one embodiment of the present invention. In one embodiment, a textured representation of the area is generated, as shown in FIGS. 6 and 8, based on the point cloud data, camera data, and/or a combination of point cloud data with visual imagery data (e.g., data generated by a drone-based system). In another embodiment, the textured representation of the area is generated based on the point cloud data, camera data, and/or a combination of point cloud data with visual imagery data (e.g., data generated by a drone-based system) of a sporting terrain. Objects 302 are then able to be identified within the space based on contrast with the surrounding environment, either based on machine vision analysis or based on relative local differences in reflectivity measurements of the LiDAR data.

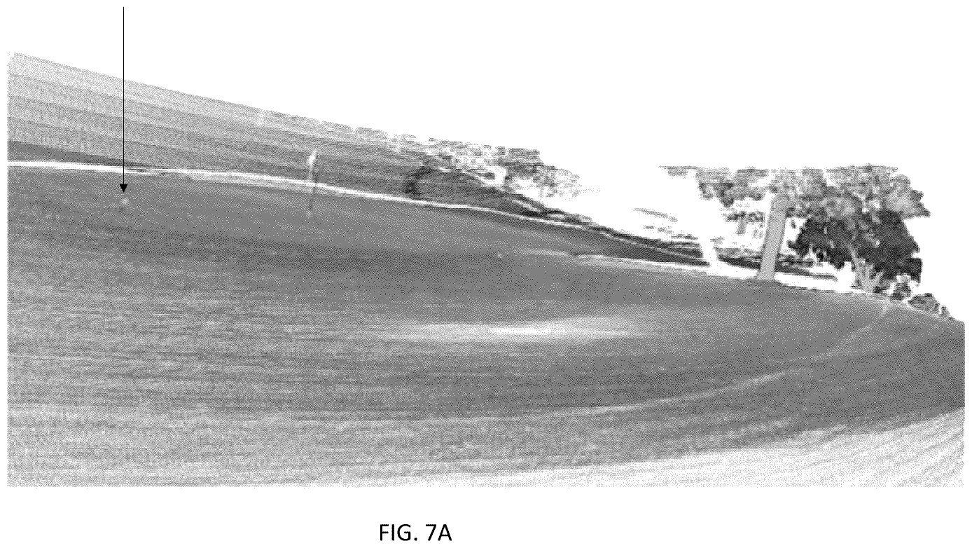

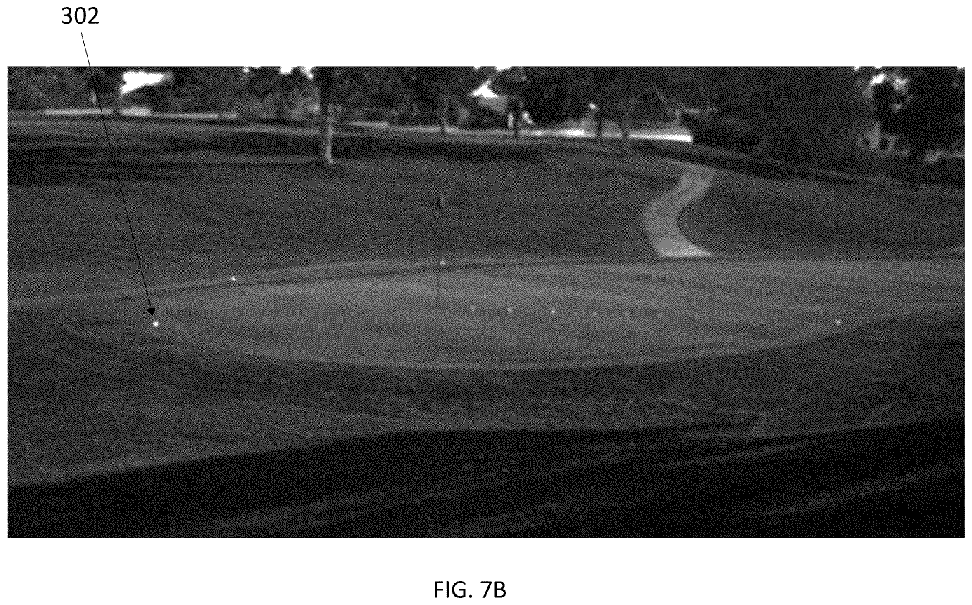

FIGS. 7A and 7B illustrates comparative views of LiDAR point cloud data and camera data generated for the same angle of a golf course according to one embodiment of the present invention. The depth information for each point in the point cloud shown in FIG. 7A pairs with the more dramatic contrast between the object (i.e., golf ball or at least one other sporting object) and the surrounding environment provided in the processed camera data shown in FIG. 7B. In another embodiment, the depth information for each point in the point cloud pairs with the more dramatic contrast between the at least one sporting object and the sporting terrain.

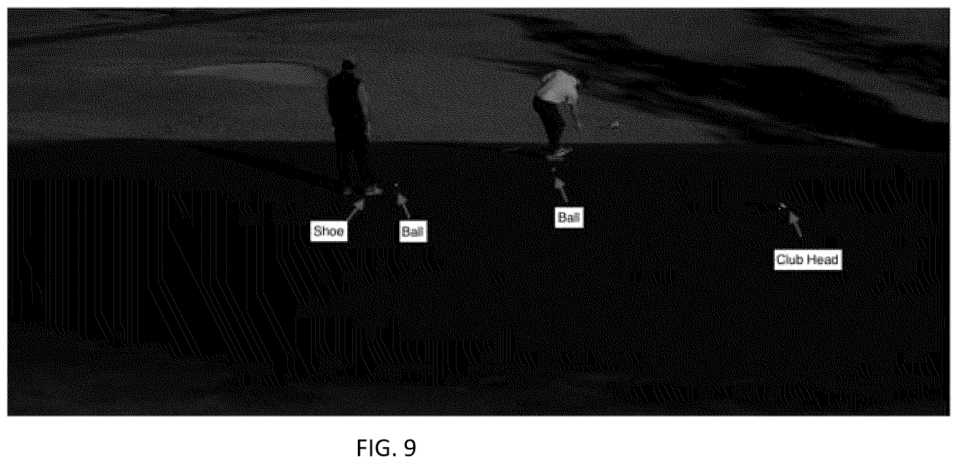

FIG. 9 illustrates a camera image with initial identification of candidate objects before candidate refinement according to one embodiment of the present invention. FIG. 9 illustrates the importance of the use of LiDAR for obtaining shape and depth indication as well as other processes of the present invention, such as circularity filtering. Purely based on color contrast from camera data, a number of different candidate objects are able to be identified, including balls, reflections off of golf club heads, and shiny portions of players' shoes. In one embodiment, candidate objects operable to be identified include any sporting object and any sporting instrument. LiDAR reflectivity measurement, contour identification, and/or circularity filtering are helpful in these situations as they eliminate candidate objects that do not correspond to the objects of interest (e.g., golf balls or at least one other sporting object). The system of the present invention is able to use reflectivity measurements, contour identification, and/or circularity filtering, either alone or in any combination.

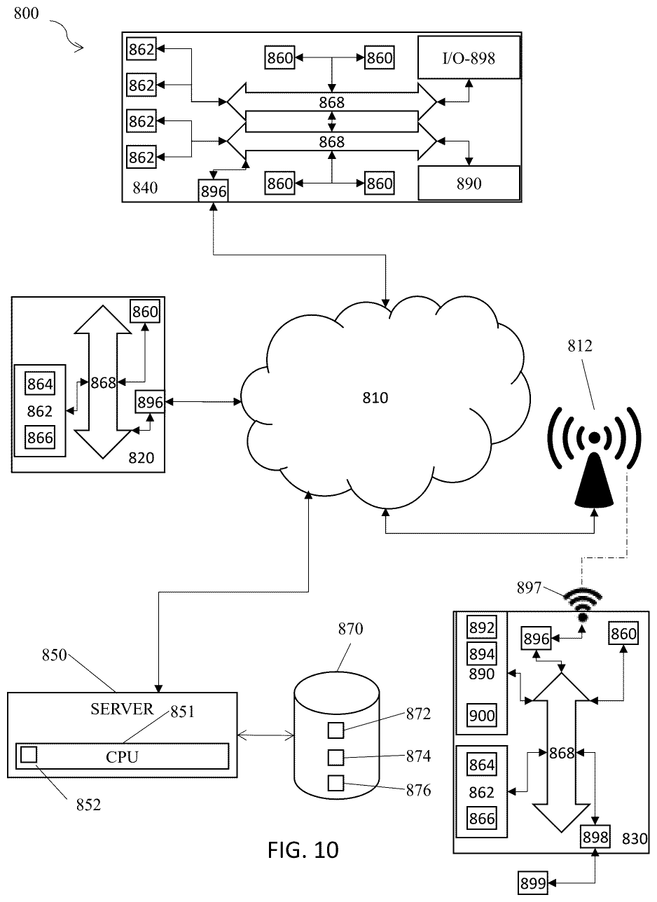

FIG. 10 is a schematic diagram of an embodiment of the invention illustrating a computer system, generally described as 800, having a network 810, a plurality of computing devices 820, 830, 840, a server 850, and a database 870.

The server 850 is constructed, configured, and coupled to enable communication over a network 810 with a plurality of computing devices 820, 830, 840. The server 850 includes a processing unit 851 with an operating system 852. The operating system 852 enables the server 850 to communicate through network 810 with the remote, distributed user devices. Database 870 is operable to house an operating system 872, memory 874, and programs 876.

In one embodiment of the invention, the system 800 includes a network 810 for distributed communication via a wireless communication antenna 812 and processing by at least one mobile communication computing device 830. Alternatively, wireless and wired communication and connectivity between devices and components described herein include wireless network communication such as WI-FI, WORLDWIDE INTEROPERABILITY FOR MICROWAVE ACCESS (WIMAX), Radio Frequency (RF) communication including RF identification (RFID), NEAR FIELD COMMUNICATION (NFC), BLUETOOTH including BLUETOOTH LOW ENERGY (BLE), ZIGBEE, Infrared (IR) communication, cellular communication, satellite communication, Universal Serial Bus (USB), Ethernet communications, communication via fiber-optic cables, coaxial cables, twisted pair cables, and/or any other type of wireless or wired communication. In another embodiment of the invention, the system 800 is a virtualized computing system capable of executing any or all aspects of software and/or application components presented herein on the computing devices 820, 830, 840. In certain aspects, the computer system 800 is operable to be implemented using hardware or a combination of software and hardware, either in a dedicated computing device, or integrated into another entity, or distributed across multiple entities or computing devices.

By way of example, and not limitation, the computing devices 820, 830, 840 are intended to represent various forms of electronic devices including at least a processor and a memory, such as a server, blade server, mainframe, mobile phone, personal digital assistant (PDA), smartphone, desktop computer, netbook computer, tablet computer, workstation, laptop, and other similar computing devices. The components shown here, their connections and relationships, and their functions, are meant to be exemplary only, and are not meant to limit implementations of the invention described and/or claimed in the present application.

In one embodiment, the computing device 820 includes components such as a processor 860, a system memory 862 having a random-access memory (RAM) 864 and a read-only memory (ROM) 866, and a system bus 868 that couples the memory 862 to the processor 860. In another embodiment, the computing device 830 is operable to additionally include components such as a storage device 890 for storing the operating system 892 and one or more application programs 894, a network interface unit 896, and/or an input/output controller 898. Each of the components is operable to be coupled to each other through at least one bus 868. The input/output controller 898 is operable to receive and process input from, or provide output to, a number of other devices 899, including, but not limited to, alphanumeric input devices, mice, electronic styluses, display units, touch screens, gaming controllers, joy sticks, touchpads, signal generation devices (e.g., speakers), augmented reality/virtual reality (AR/VR) devices (e.g., AR/VR headsets), or printers.

By way of example, and not limitation, the processor 860 is operable to be a general-purpose microprocessor (e.g., a central processing unit (CPU)), a graphics processing unit (GPU), a microcontroller, a Digital Signal Processor (DSP), an Application Specific Integrated Circuit (ASIC), a Field Programmable Gate Array (FPGA), a Programmable Logic Device (PLD), a controller, a state machine, gated or transistor logic, discrete hardware components, or any other suitable entity or combinations thereof that can perform calculations, process instructions for execution, and/or other manipulations of information.

In another implementation, shown as 840 in FIG. 10, multiple processors 860 and/or multiple buses 868 are operable to be used, as appropriate, along with multiple memories 862 of multiple types (e.g., a combination of a DSP and a microprocessor, a plurality of microprocessors, one or more microprocessors in conjunction with a DSP core).

Also, multiple computing devices are operable to be connected, with each device providing portions of the necessary operations (e.g., a server bank, a group of blade servers, or a multiprocessor system). Alternatively, some steps or methods are operable to be performed by circuitry that is specific to a given function.

According to various embodiments, the computer system 800 is operable to operate in a networked environment using logical connections to local and/or remote computing devices 820, 830, 840 through a network 810. A computing device 830 is operable to connect to a network 810 through a network interface unit 896 connected to a bus 868. Computing devices are operable to communicate communication media through wired networks, direct-wired connections or wirelessly, such as acoustic, RF, or infrared, through an antenna 897 in communication with the network antenna 812 and the network interface unit 896, which are operable to include digital signal processing circuitry when necessary. The network interface unit 896 is operable to provide for communications under various modes or protocols.

In one or more exemplary aspects, the instructions are operable to be implemented in hardware, software, firmware, or any combinations thereof. A computer readable medium is operable to provide volatile or non-volatile storage for one or more sets of instructions, such as operating systems, data structures, program modules, applications, or other data embodying anyone or more of the methodologies or functions described herein. The computer readable medium is operable to include the memory 862, the processor 860, and/or the storage media 890 and is operable to be a single medium or multiple media (e.g., a centralized or distributed computer system) that store the one or more sets of instructions 900. Non-transitory computer readable media includes all computer readable media, with the sole exception being a transitory, propagating signal per se. The instructions 900 are further operable to be transmitted or received over the network 810 via the network interface unit 896 as communication media, which is operable to include a modulated data signal such as a carrier wave or other transport mechanism and includes any delivery media. The term “modulated data signal” means a signal that has one or more of its characteristics changed or set in a manner as to encode information in the signal.

Storage devices 890 and memory 862 include, but are not limited to, volatile and non-volatile media such as cache, RAM, ROM, EPROM, EEPROM, FLASH memory, or other solid state memory technology; discs (e.g., digital versatile discs (DVD), HD-DVD, BLU-RAY, compact disc (CD), or CD-ROM) or other optical storage; magnetic cassettes, magnetic tape, magnetic disk storage, floppy disks, or other magnetic storage devices; or any other medium that can be used to store the computer readable instructions and which can be accessed by the computer system 800.

In one embodiment, the computer system 800 is within a cloud-based network. In one embodiment, the server 850 is a designated physical server for distributed computing devices 820, 830, and 840. In one embodiment, the server 850 is a cloud-based server platform. In one embodiment, the cloud-based server platform hosts serverless functions for distributed computing devices 820, 830, and 840.

In another embodiment, the computer system 800 is within an edge computing network. The server 850 is an edge server, and the database 870 is an edge database. The edge server 850 and the edge database 870 are part of an edge computing platform. In one embodiment, the edge server 850 and the edge database 870 are designated to distributed computing devices 820, 830, and 840. In one embodiment, the edge server 850 and the edge database 870 are not designated for distributed computing devices 820, 830, and 840. The distributed computing devices 820, 830, and 840 connect to an edge server in the edge computing network based on proximity, availability, latency, bandwidth, and/or other factors.

It is also contemplated that the computer system 800 is operable to not include all the components shown in FIG. 10, is operable to include other components that are not explicitly shown in FIG. 10, or is operable to utilize an architecture completely different from that shown in FIG. 10. The various illustrative logical blocks, modules, elements, circuits, and algorithms described in connection with the embodiments disclosed herein are operable to be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application (e.g., arranged in a different order or partitioned differently), but such implementation decisions should not be interpreted as causing a departure from the scope of the present invention.

Certain modifications and improvements will occur to those skilled in the art upon a reading of the foregoing description. For example, modification of the present invention for applicability to other sports, including but not limited to, baseball, tennis, basketball, volleyball, hockey, football, soccer, cricket, and/or other sports is contemplated herein. While the present invention is described primarily with respect to detection of objects, one of ordinary skill in the art understands that this technology is operable to be used to detect one or more players using, for example, apparel such as jerseys, gloves, or shoes, or skin and the reflectivity of these materials. The above-mentioned examples are provided to serve the purpose of clarifying the aspects of the invention, and it will be apparent to one skilled in the art that they do not serve to limit the scope of the invention. All modifications and improvements have been deleted herein for the sake of conciseness and readability but are properly within the scope of the present invention.

The invention claimed is:

1. A light detection and ranging (LiDAR)-based system for identifying and locating a sporting object comprising:
a processor, at least one LiDAR sensor, and at least one visual camera sensor;
wherein the processor is in communication with the at least one LiDAR sensor and the at least one visual camera sensor, wherein the processor includes a computer vision analysis module;
wherein the at least one visual camera sensor is configured to capture a snapshot of an area to generate visual camera data;
wherein the computer vision analysis module is configured to utilize a machine learning (ML) algorithm to determine at least one region of interest (ROI) based on the visual camera data, wherein the at least one ROI includes at least one candidate area;
wherein the at least one LiDAR sensor is configured to perform a LiDAR scan of the at least one ROI to determine a location of the sporting object and generate LiDAR data; and
wherein the processor is operable perform a reflectivity analysis to determine whether the at least one candidate area includes the sporting object based on the LiDAR data and a reflectivity threshold.

2. The system of claim 1, further comprising a housing to contain the at least one visual camera sensor.

3. The system of claim 2, further comprising a mounting bracket operable to connect the housing to the at least one LiDAR sensor.

4. The system of claim 1, wherein the at least one LiDAR sensor is operable to return at least two pulses and an elongation value between the at least two pulses.

5. The system of claim 4, wherein the at least one LiDAR sensor is operable to distinguish the at least one candidate area from the area surrounding the at least one candidate area based on the elongation value.

6. The system of claim 1, wherein the processor further includes circularity filtering, wherein the processor utilizes the circularity filtering to determine whether the at least one candidate area includes the sporting object based on the LiDAR scan and a circularity threshold.

7. The system of claim 1, further comprising a stand operable to elevate the LiDAR-based system, wherein the LiDAR-based system is attached to the stand.

8. The system of claim 1, wherein the processor is operable to utilize temporal frame analysis and determine if the at least one candidate area is the sporting object based on movement patterns.

9. The system of claim 1, further comprising a band pass filter for visual camera data, wherein the band pass filter is operable to provide an increase in measured brightness of the sporting object relative to the area.

10. A light detection and ranging (LiDAR)-based system for identifying and locating a sporting object comprising:
a processor, at least one LiDAR sensor, and at least one visual camera sensor; and
at least one battery configured to provide power to the at least one visual camera sensor and the at least one LiDAR sensor;
wherein the processor is in communication with the at least one LiDAR sensor and the at least one visual camera sensor, wherein the processor includes a computer vision analysis module and a circularity filter, and wherein the processor is operable to perform a reflectivity analysis;
wherein the at least one LiDAR sensor is configured to perform a LiDAR scan of an area to determine at least one region of interest (ROI) based on the reflectivity analysis and the circularity filter;
wherein the reflectivity analysis and the circularity filter are operable to determine if the at least one ROI comprises at least one candidate area based on the LiDAR scan, a reflectivity threshold, a circularity threshold, and a circularity algorithm;
wherein the at least one visual camera sensor is configured to perform a snapshot of the ROI to generate visual camera data; and
wherein the computer vision analysis module is configured to utilize a machine learning (ML) algorithm to confirm or deny if the at least one candidate area includes the sporting object based on the visual camera data.

11. The system of claim 10, further comprising a housing to contain the at least one visual camera sensor.

12. The system of claim 11, further comprising a mounting bracket operable to connect the housing to the at least one LiDAR sensor.

13. The system of claim 10, wherein the at least one LiDAR sensor is operable to return at least two pulses and an elongation value between the at least two pulses.

14. The system of claim 10, further comprising a band pass filter for the visual camera data, wherein the band pass filter is operable to increase measured brightness of the sporting object relative to the area.

15. The system of claim 10, wherein the LiDAR-based system is operable to cross-correlate the at least one candidate area from the LiDAR scan and the snapshot to reduce false positives and false negatives.

16. A light detection and ranging (LiDAR)-based method for identifying and locating a sporting object comprising:
scanning an area, using at least one LiDAR sensor, to determine at least one region of interest (ROI) and generate LiDAR data;
determining, using a reflectivity analysis and a circularity filter, at least one candidate area in the at least one ROI based on the LiDAR data, a reflectivity threshold, a circularity threshold, and a circularity algorithm;
performing a snapshot of the at least one ROI, using at least one visual camera sensor, to generate visual camera data; and
confirming or denying, using a computer vision analysis module, if the at least one candidate area includes the sporting object based on the visual camera data.

17. The method of claim 16, further comprising returning, via the at least one LiDAR sensor, at least two pulses and an elongation value between the at least two pulses.

18. The method of claim 16, further comprising cross-correlating the at least one candidate area from the scan from the at least one LiDAR sensor and the snapshot to reduce false positives and false negatives.

19. The method of claim 16, further comprising determining, using temporal frame analysis, that the at least one candidate area is the sporting object based on movement patterns.

20. The method of claim 16, further comprising filtering the visual camera data, using a band pass filter, to increase measured brightness of the sporting object relative to the area.
